(19) United States
(12) Patent Application Publication
(10) Pub. No.: US 2012/0229040 A1
(43) Pub. Date: Sep. 13, 2012

(54) METHOD AND APPARATUS TO FACILITATE COUPLING AN LED-BASED LAMP TO A FLOURESCENT LIGHT FIXTURE

(75) Inventors: Wendell Brown, Henderson, NV (US); Jonathan Fram, Beverly Hills, CA (US)

(73) Assignee: NULARIS INC., West Hollywood, CA (US)

(21) Appl. No.: 13/414,921

(22) Filed: Mar. 8, 2012

Related U.S. Application Data
(60) Provisional application No. 61/451,816, filed on Mar. 11, 2011.

(51) Int. Cl. H05B 37/00

(52) U.S. Cl. 315/200 R; 315/312

(57) ABSTRACT

Some embodiments described herein provide methods and apparatuses to facilitate coupling a light-emitting diode (LED)-based lamp to an electronic or inductive fluorescent light fixture (typically with ballast). Specifically, some embodiments include circuitry that simulates an electrical behavior of a fluorescent lamp. The embodiments also include one or more LEDs that are controlled by the circuitry.

### RELATED APPLICATION

This application claims priority to U.S. Provisional Application No. 61/451,816, entitled “Light-emitting apparatus for replacing a fluorescent light,” by the same inventors, filed on 11 Mar. 2011, the contents of which are herein incorporated by reference.

### BACKGROUND

1. Technical Field

This disclosure relates to light-emitting apparatuses. More specifically, this disclosure relates to methods and apparatuses to facilitate coupling a light-emitting diode (LED)-based lamp to a fluorescent light fixture.

2. Related Art

There are millions of existing florescent light fixtures installed in businesses, buildings, homes, schools, malls, factories and other locations. A new generation of LED lights offers more energy efficiency and longer life.

### SUMMARY

Some embodiments described herein provide methods and apparatuses to facilitate coupling a “plug replacement ready” LED-based lamp to an existing inductive or electronic fluorescent light fixture (typically with ballast).

Many existing florescent light fixtures are not directly compatible with plug-in replacement LED light lamps, on a “plug-n-play” basis without altering the existing fixture wiring (for example, by removing the starter, shorting across the ballast, etc). Some embodiments described herein provide circuitry that may be contained within the LED-based lamp which allows the existing florescent circuitry to directly drive the LED-based lamp without modification to the existing florescent fixture or circuitry.

### BRIEF DESCRIPTION OF THE FIGURES

FIG. 1 illustrates a block diagram for an LED-based lamp in accordance with some embodiments described herein.

FIG. 2 illustrates a process to operate an LED-based lamp that is coupled to a fluorescent light fixture in accordance with some embodiments described herein.

FIG. 3 illustrates a block diagram for an LED-based lamp in accordance with some embodiments described herein.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a non-transitory computer-readable storage medium, which may be any device or medium that can store code and/or data for use by a computer system. The term non-transitory computer-readable storage medium includes all computer-readable storage mediums with the sole exception of a propagating electromagnetic wave or signal. This includes, but is not limited to, volatile memory, non-volatile memory, magnetic and optical storage devices such as disk drives, magnetic tape, compact discs, DVDs (digital versatile discs or digital video discs), or other non-transitory computer-readable media now known or later developed.

As used in this disclosure, the term “lamp” refers to an apparatus that converts electricity into light. In some fluorescent lamps, electricity is used to excite mercury atoms, and the excited mercury atoms produce ultraviolet light. The ultraviolet light, in turn, causes phosphor (which is also in the lamp) to fluorescence, thereby producing visible light.

Operating a fluorescent lamp requires circuitry to start the lamp by ionizing the vapor in the lamp and to limit the amount of current flowing through the vapor once the lamp has been started. Typical florescent lamp fixtures contain either an electronic or an inductive (magnetic) ballast. They also contain a starter circuit which fires a short, high-voltage spike to initially light the florescent lamp by striking an arc across the ionized vapor. Neither of these are necessary for LED lights, but it is desirable (for ease of upgrade) to couple the new replacement LED lights to work with the existing florescent lamp circuitry (i.e., a ballast and/or starter).

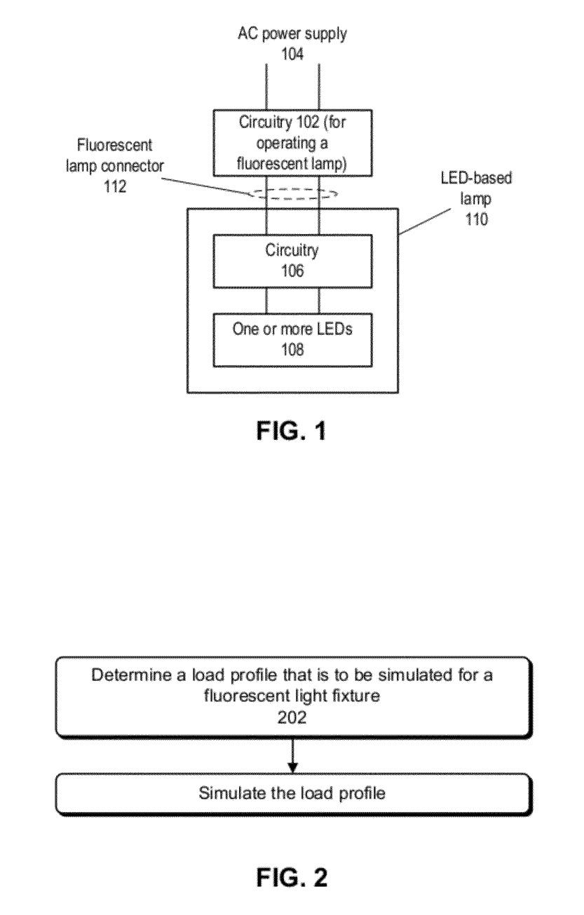

FIG. 1 illustrates a block diagram for an LED-based lamp in accordance with some embodiments described herein. The LED-based lamp shown in FIG. 1 is for illustration purposes only and is not intended to limit the embodiments described herein. Accordingly, many modifications and variations will be apparent to practitioners skilled in the art.

Circuitry 102 is part of a fluorescent lamp fixture, and is specifically designed to operate fluorescent lamps. A fluorescent lamp (not shown) can be coupled to circuitry 102 through fluorescent lamp connector 112. Circuitry 102 receives power from alternating current (AC) power supply 104. Circuitry 102 starts the fluorescent lamp by providing a high-voltage spike to the lamp, and then regulates the current in the lamp after the lamp has been started. If a lamp that does not electrically behave like a fluorescent lamp is coupled to circuitry 102, then the lamp may malfunction and/or cause circuitry 102 to malfunction.

An LED does not electrically behave like a fluorescent lamp. Therefore, an LED-based lamp cannot be directly coupled to a light fixture that is designed for a fluorescent lamp. Some embodiments described herein provide an LED-based lamp (e.g., LED-based lamp 110) that is capable of being coupled to a fluorescent lamp connector (e.g., fluorescent lamp connector 112) and that is compatible with circuitry that is designed to operate a fluorescent lamp (e.g., circuitry 102).

LED-based lamp 110 includes circuitry 106 and one or more LEDs 108. Circuitry 106 simulates the electrical behavior of a fluorescent lamp, thereby causing circuitry 102 to operate correctly. Circuitry 106 also controls and provides power to one or more LEDs 108. Circuitry 106 can include analog and/or digital components.

FIG. 2 illustrates a process to operate an LED-based lamp that is coupled to a fluorescent light fixture in accordance with some embodiments described herein.

The process begins by determining a load profile that is to be simulated for a fluorescent light fixture (operation 202). According to one definition, the term “load profile” refers to the variation of an impedance value over time (e.g., a load profile may specify that the load is equal to a first impedance value during the first 100 milliseconds, and thereafter the load tapers off from the first impedance value to a second impedance value over the next 5 seconds). For example, the load profile of a fluorescent tube is the variation of the impedance value over time of the fluorescent tube that is seen by circuitry 102. According to one definition, the term “load profile that is to be simulated for a fluorescent light fixture” is the load profile that causes the circuitry (e.g., circuitry 102) in the fluorescent light fixture to operate in substantially the same way it would have operated if a fluorescent bulb had been coupled to the fluorescent lamp connector (e.g., fluorescent lamp connector 112) of the fluorescent light fixture.

In some embodiments, circuitry 106 in the LED-based lamp 110 can determine whether the LED-based lamp is plugged into an electronic or mechanical (inductive) ballast. This can be determined using several approaches.

In a first approach, circuitry 106 can analyze the frequency (chop) of the incoming current. Electronic ballasts are similar to switching power supplies and thus circuitry 106 can examine the incoming voltage/current (output from the electronic ballast) and sense a high-frequency chop as produced by an electronic ballast. An inductive ballast, on the other hand, does not produce a high-frequency chop.

In a second approach, circuitry 106 can vary the load (on the electronic or inductive ballast) to detect if and how the frequency changes (if so, circuitry 106 can confirm that the LED is plugged into an electronic ballast).

In a third approach, a manual DIP (dual in-line package) switch setting or other selection mechanism can be used to toggle through configuration options. The switch (which may be located on the LED-based lamp) could be set to auto-configure, or set to manually configure to drive a particular load program. A human installer may manually configure the LED-based lamp's DIP switch to correspond to the ballast type/model/manufacturer. Circuitry 106 can sense the DIP switch setting and provide a load to circuitry 102 accordingly.

In a fourth approach, circuitry 106 can analyze the time ramp of voltage/current supplied by the ballast—either in start mode or continual. The ramp of the voltage/current supplied ballast is different for electronic and magnetic ballasts. Therefore, the time ramp can be used to detect the type of ballast.

In a fifth approach, circuitry 106 can analyze other characteristics of an inductor load (inductive kick, time ramps, reverse kick when the ballast disconnects, etc.) to determine whether circuitry 102 includes an electronic or magnetic ballast.

In a sixth approach, circuitry 106 can perform an “auto configure” process in which LED-based lamp 110 cycles through, and tests, which modes work the best, and then circuitry 106 can store the best mode, which can then be used subsequently when LED-based lamp 110 is turned on. For example, a simple “reset” switch or a “run auto configure” switch could be set on LED-based lamp 110 once LED-based lamp 110 has been installed. In this embodiment, LED-based lamp 110 may include read-only memory (ROM) or Flash memory, which LED-based lamp 110 can use to store the mode that was determined during the auto-configure process. In some embodiments, if LED-based lamp 110 hasn't been configured (i.e., LED-based lamp 110 is fresh from the factory) then LED-based lamp 110 may perform the “auto configure” process itself when it powers up the first time. In some embodiments, LED-based lamp 110 could also flash at certain rates to visually indicate to the installer that it is currently self-configuring, or indicate that it is in a particular operational mode, and/or indicate if an error condition has occurred.

After the load profile that is to be simulated for the fluorescent light fixture has been determined, the process can simulate the load profile (operation 204). For example, circuitry 106 can include a processor and a memory, wherein the memory can store instructions that, when executed by the processor cause LED-based lamp 110 to simulate the electrical behavior of a particular type of fluorescent lamp. For example, the memory may store instructions for a set of “simulation modes”, wherein each simulation mode corresponds to a different “load program” that creates a load onto the ballast which suites the drive characteristics of an electronic ballast or a mechanical (inductive) ballast. There could be multiple load programs that are configured either by auto-detection of the ballast type or configured by manual configuration (e.g., based on a DIP switch that is manually configured by a human installer to correspond to the ballast type/model/manufacturer).

The load program can simulate the electrical behavior that is expected of the simulated fluorescent lamp during the starting phase and also when the simulated fluorescent lamp has been turned on. Specifically, the current draw that circuitry 106 emulates when the simulated fluorescent lamp has been turned on might be different depending on whether circuitry 106 detected an electronic ballast or a mechanical (inductive) ballast.

In some embodiments, an inductive ballast in circuitry 102 may not operate properly if the current draw is too low. Multiple approaches can be used to provide an appropriate level of current draw. In some embodiments, circuitry 106 can perform slow time slicing of the LED load. In these embodiments, circuitry 106 includes a capacitor that can buffer enough power to keep the LEDs on for a first time duration (e.g., 10 seconds). Circuitry 106 presents a normal current load to the ballast in circuitry 102 for a second time duration (e.g., 1 second), and fills up the capacitor. Next, circuitry 106 disconnects from circuitry 102 (and therefore disconnects from the ballast in circuitry 102). After circuitry 106 disconnects, the LEDs remain on by drawing current from the capacitor for a third time duration (which, in some embodiments, is equal to the difference between the first and second time durations, e.g., 9 seconds). At the end of the third time duration, circuitry 106 reconnects to circuitry 102 and recharges the capacitor by presenting a normal load to circuitry 102 for a duration that is equal to the first time duration. This “slow time switching” technique (“slow” because it cycles in seconds, not milliseconds) can be used for both electronic as well as inductive ballasts. The “load” could start/end either binary (on/off) or in smaller steps (load slowly rise/fall over say 256 steps, over say 1 second) to avoid sudden stresses on the ballast (e.g., to make the ballast last longer and/or to reduce noise, e.g., avoid 1-second buzz and/or popping sound every 10 seconds).

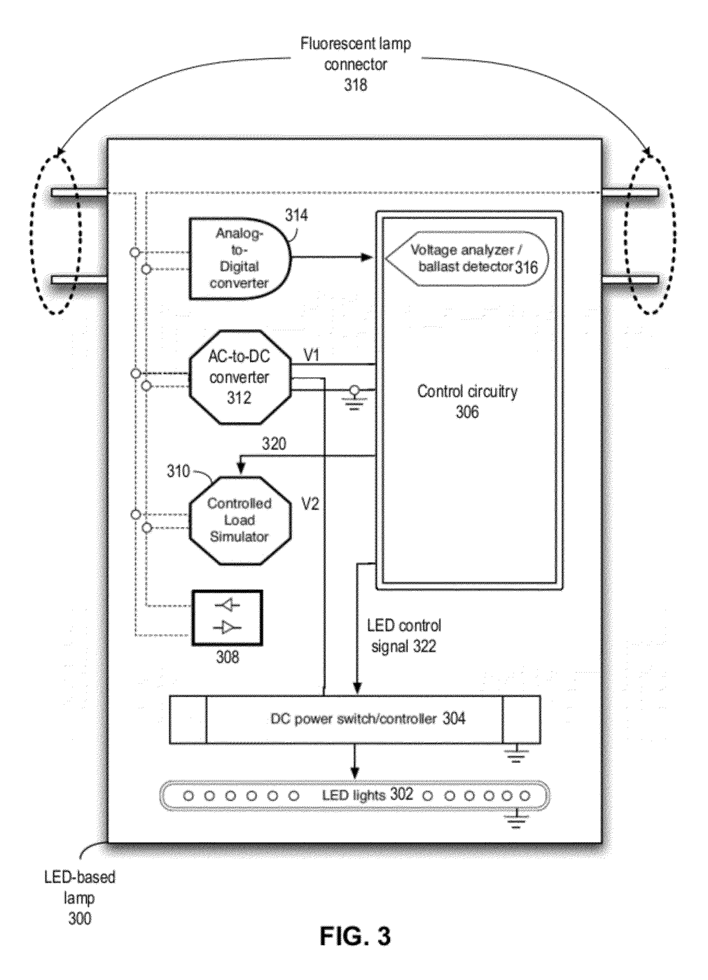

FIG. 3 illustrates a block diagram for an LED-based lamp in accordance with some embodiments described herein.

LED-based lamp 300 includes analog-to-digital converter (ADC) 314, voltage analyzer/ballast detector 316, AC (alternating current)-to-DC (direct current) converter 312, control circuitry 306, controlled load simulator 310, one or more zener diodes 308, DC power switch/controller 304, and LED lights 302. Fluorescent lamp connector 318 is used to couple LED-based lamp 300 into a fluorescent lamp fixture.

The starter's high-voltage spike can be effectively shunted through the use of one or more zener diode 308. In other embodiments, the one or more zener diodes can be replaced with a silicon controlled rectifier, and/or a high-voltage TRIAC (triode for alternating current) can be used to effectively short-out the starter spike. Note that the high-voltage spike is still produced by the florescent starter, but the high-voltage spike is rendered harmless by the shorting effect of one or more zener diodes 308 (or other circuitry that is capable of shorting the high-voltage spike). If the florescent starter module is manually removed, then the embodiment may not require one or more zener diodes 308 or other circuitry that is capable of shorting the high-voltage spike.

AC-to-DC converter 312 can supply DC power to control circuitry 306 and to LED lights 302 through DC power switch/controller 304. In some embodiments, AC-to-DC converter 312 can supply different DC voltages to different parts of LED-based lamp 300, e.g., AC-to-DC converter 312 can supply voltage V1 to control circuitry 306 and voltage V2 to LED lights 302 through DC power switch/controller 304.

ADC 314 can sense the voltage across two wires of fluorescent lamp connector 308, and convert the voltage value into a digital value that can be processed by control circuitry 306. Specifically, control circuitry 306 can include voltage analyzer/ballast detector 316 to determine whether the fluorescent light fixture uses an electronic or inductive ballast based on the digital value provided by ADC 314.

Control circuitry 306 can generate control signal 320 based on a load profile. Control load simulator 310 (also referred to as load simulator circuitry in this disclosure) can present a dynamic (i.e., time-varying) load across two wires of fluorescent lamp connector 308 based on control signal 320 that is received from control circuitry 306. For example, control load simulator 310 can present a load that is equal to a first impedance value for 100 milliseconds, and thereafter present a load that tapers off from the first impedance value to a second impedance value over the next 5 seconds. Control circuitry 306 can also provide LED control signal 322 to DC power switch/controller 304 to turn on, turn off, and/or increase/decrease intensity of LED lights 302.

As explained above, the circuitry in LED-based lamp 300 acts to effectively simulate the current/voltage consumption of a florescent tube, as seen by the ballast. Effectively, the circuitry in LED-based lamp 300 tricks the ballast into producing the necessary voltage/current characteristics in order to make the ballast think it's driving a florescent tube.

In some embodiments, control circuitry 306 can include a low-performance processor with RAM (random access memory), ROM (read only memory), and/or analog control circuitry. In some embodiments, control circuitry 306 is reset or activated by the high-voltage “starter spike” produced by the existing florescent fixture's starter module. In some embodiments, control circuitry 306 is reset or activated by the presence of incoming voltage output of the ballast. Once control circuitry 306 is reset or activated, it then begins a time-controlled artificial resistance and/or inductive load to simulate the load characteristics of a typical florescent tube. In this manner, control circuitry 306 effectively tricks the ballast into believing that it is driving an actual florescent tube.

### Variations and Modifications

Some embodiments described herein allow direct LED replacement of a typical florescent tube, with no changes needed to the florescent fixture, and all components, including the ballast can remain in line. In some embodiments, the extra circuitry (e.g., circuitry 106 shown in FIG. 1) is contained within the replacement LED-based lamp, which alleviates the need for manual rewiring or changing of the florescent fixture or its wiring.

Some embodiments provide an LED-based lamp that is configurable to best match the expected load of the ballast to which it is connected. Selecting the configuration mode could be done via an automated process or via a manual setting configuration setting. In some embodiments, the LED-based lamp is configurable, e.g., a DIP switch can be used to configure one or more characteristics of one or more LEDs in the LED-based lamp. These characteristics include, but are not limited to, brightness, color, whether an LED turns on or off suddenly or gradually, whether an LED is capable of being dimmed, or whether an LED is capable of being programmed to turn on or off after a predetermined duration.

Some embodiments described herein provide an LED-based lamp that is designed to be physically and plug-compatible with existing fluorescent fixtures/connectors, wherein the LED-based lamp is configured to be electronically compatible with the ballast it is connected to. In some embodiments, one or more characteristics of one or more LEDs are capable of being configured by a communication device (e.g., based on information received from the communication device over a wireless channel such as WiFi or Bluetooth), by detection of an electromagnetic signal (e.g., time of day radio broadcast, bits detected in a TV signal vertical broadcasts, etc.), by detection of an audio signal (e.g., voice activated, clap activated, etc.), and/or by manual configuration by the user (e.g., by turning an existing switch on/off/on/off a certain number of times within a short period of time). A communication device refers to any device that is capable of communicating with other devices over a wireless channel, such as (but not limited to) a smart phone (e.g., an iPhone), a tablet computer, a laptop computer, a desktop computer, a wireless router, a cell tower, etc.

In some embodiments, the LED-based lamp's output (brightness, color, etc) could also be “turned on” and “turned off” gradually (e.g., by using 256 steps) to create a more visually appealing on/off operation (instead of a sudden on/off operation). In some embodiments, the LED-based lamp is configured so that a user could “signal” (on/off) to the bulb to “stop” the dimness at a certain point in its gradual turn-on cycle, thereby allowing the user to select a certain dim level according to the time between the user's cycling of the existing wall power switch.

In some embodiments, the LED-based lamp is designed either as a new standalone device or as an existing fluorescent bulb replacement device (as determined by the LED-based lamp's size/connectors to match existing fixtures).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. An apparatus, comprising:
circuitry to couple the apparatus to a fluorescent light fixture, wherein the circuitry simulates an electrical behavior of a fluorescent lamp; and
one or more light-emitting diodes (LEDs) that are controlled by the circuitry.

2. The apparatus of claim 1, wherein the circuitry includes a processor and a memory, wherein the memory stores instructions that, when executed by the processor, cause the circuitry to simulate the electrical behavior of the fluorescent lamp.

3. The apparatus of claim 1, wherein the circuitry comprises shorting circuitry to short a voltage spike that is received from the fluorescent light fixture for starting a fluorescent lamp.

4. The apparatus of claim 3, wherein the shorting circuitry comprises one or more zener diodes.

5. The apparatus of claim 1, wherein the circuitry includes ballast-detection circuitry to detect a type of ballast that is being used by the fluorescent light fixture.

6. The apparatus of claim 1, wherein the circuitry includes an alternating current (AC) to direct current (DC) converter to power the one or more LEDs.

7. The apparatus of claim 1, wherein the circuitry includes load simulator circuitry that is capable of varying a load across a pair of terminals based on a control signal.

8. The apparatus of claim 1, wherein the circuitry includes an analog-to-digital converter (ADC) to determine a digital value corresponding to a voltage supplied by the fluorescent light fixture to the apparatus.

9. The apparatus of claim 1, wherein the circuitry is capable of determining a load profile that is to be simulated for the fluorescent light fixture.

10. The apparatus of claim 1, further comprising a dual in-line package switch to configure one or more characteristics of the one or more LEDs.

11. The apparatus of claim 10, wherein a characteristic is one of: brightness, color, whether an LED turns on/off suddenly or gradually, whether an LED is capable of being dimmed, or whether an LED is capable of being programmed to turn on/off after a predetermined duration.

12. The apparatus of claim 1, wherein the circuitry includes wireless circuitry to communicate with a communication device over a wireless channel.

13. The apparatus of claim 12, wherein the circuitry configures one or more characteristics of one or more LEDs based on information received from the communication device over the wireless channel.

14. The apparatus of claim 13, wherein a characteristic is one of: brightness, color, whether an LED turns on/off suddenly or gradually, whether an LED is capable of being dimmed, or whether an LED is capable of being programmed to turn on/off after a predetermined duration.

15. A method to facilitate coupling a light-emitting diode (LED)-based lamp to a fluorescent light fixture, the method comprising:
determining a load profile that is to be simulated for the fluorescent light fixture coupled to the LED-based lamp, wherein the LED-based lamp include one or more LED lights; and
simulating the load profile.

16. The method of claim 15, wherein determining the load profile includes determining whether the fluorescent light fixture includes an electronic or inductive ballast.

17. A non-transitory computer-readable storage medium storing instructions that, when executed by a processor, causes the processor to perform a method to facilitate coupling a light-emitting diode (LED)-based lamp to a fluorescent light fixture, the method comprising:
determining a load profile that is to be simulated for the fluorescent light fixture that is coupled to the LED-based lamp, wherein the LED-based lamp include one or more LED lights; and
simulating the load profile.

18. The non-transitory computer-readable storage medium of claim 17, wherein determining the load profile includes determining whether the fluorescent light fixture includes an electronic or inductive ballast.
